(19) United States
(12) Patent Application Publication
(10) Pub. No.: US 2025/0124555 A1
(43) Pub. Date: Apr. 17, 2025

(54) IMAGE SPECIFIC GLOBAL TONE CURVE AND RESIDUAL GAIN MAP GENERATION BASED ON MULTIPLE IMAGES

(71) Applicant: Apple Inc., Cupertino, CA (US)

(72) Inventors: Ching E. HO, San Jose, CA (US); Jackson K. ROLAND, San Jose, CA (US); Nicolas P. BONNIER, Mountain View, CA (US)

(21) Appl. No.: 18/900,476

(22) Filed: Sep. 27, 2024

Related U.S. Application Data
(60) Provisional application No. 63/589,616, filed on Oct. 11, 2023.
(60) Provisional application No. 63/589,960, filed on Oct. 12, 2023.

(51) Int. Cl. G06T 5/92; G06T 5/50

(52) U.S. Cl. CPC G06T 5/92; G06T 5/50; G06T 2207/10144; G06T 2207/20208

(57) ABSTRACT

Disclosed are various techniques for generating image specific global tone curves and residual gain maps based on multiple images. A gain map is generated based on a comparison of a first image to a second image. A gain map scatter plot is constructed based on the gain map values and channel values of either the first image or the second image. An image specific global tone curve is determined by curve fitting to the gain map scatter plot. A residual gain map is generated based on a comparison of the gain map to a reconstructed gain map derived from the image specific global tone curve. An approximation of the second image can be constructed using the image specific global tone curve and the first image. A replica of the second image can be constructed using the image specific global tone curve, the residual gain map, and the first image.

### CROSS-REFERENCE TO RELATED APPLICATIONS

The present application claims the benefit of U.S. Provisional Application No. 63/589,616, filed Oct. 11, 2023, entitled “IMAGE SPECIFIC GLOBAL TONE CURVE AND RESIDUAL GAIN MAP GENERATION BASED ON MULTIPLE IMAGES,” and U.S.

Provisional Application No. 63/589,960, filed Oct. 12, 2023, of the same title, the contents of all of which are incorporated by reference herein in their entirety for all purposes.

### FIELD OF INVENTION

The embodiments described herein set forth techniques for generating image specific global tone curves and residual gain maps based on multiple images. In particular, a gain map can be generated based on a comparison of a first image to a second image. A gain map scatter plot can be constructed based on the gain map values and luma (channel) values of either the first image or the second image. An image specific global tone curve can be determined by curve fitting to the gain map scatter plot, and a residual gain map can be generated based on a comparison of the gain map to a reconstructed gain map derived from the image specific global tone curve.

### BACKGROUND

The dynamic range of an image refers to the range of pixel values between the image's lightest and darkest parts (often referred to as “luminance”). Notably, conventional image sensors can only capture a limited range of luminance in a single exposure of a scene, at least relative to what human eyes are able to perceive from the same scene. This limited range is typically referred to as standard dynamic range (SDR) in the world of digital photography.

Despite the foregoing image sensor limitations, improvements in photography techniques have enabled wider ranges of light to be captured (referred to herein as high dynamic range (HDR)). This can be achieved by (1) capturing multiple “bracketed” images, i.e., images with different exposure times, and then (2) combining the bracketed images into a single image that incorporates different aspects of the different exposures. In this regard, the single HDR image possesses a wider dynamic range of luminance in comparison to what otherwise can be captured in each of the individual exposures. This makes HDR images superior to SDR images in several aspects.

Display devices capable of displaying HDR images (in their true form) are becoming more accessible due to advancements in design and manufacturing technologies. However, a majority of display devices that are currently in use (and continue to be manufactured) are only capable of displaying SDR images. Consequently, devices with SDR-limited displays that receive HDR images must perform various tasks to convert (i.e., downgrade) the HDR image to an SDR image equivalent. Conversely, devices with HDR-capable displays that receive SDR images may attempt to perform various tasks to convert (i.e., upgrade) the SDR image to an HDR image equivalent.

Conversion of images from an HDR image to an SDR image or from an SDR image to an HDR image using a fixed global tone curve can generate alternative versions of an image that differ from intentions of a creator or originator of the original image.

Accordingly, what is needed is a technique for enabling images to be efficiently and accurately transitioned between different versions of the image while more accurately maintaining an image creator's intent.

### SUMMARY OF INVENTION

Representative embodiments described herein set forth techniques for generating image specific global tone curves and residual gain maps based on multiple images. A gain map scatter plot can be constructed based on gain map values and luma (channel) values of either the first image or the second image, where the gain map represents a mapping between pixels (or more generally unit areas) of the first image and pixels (unit areas) of the second image. In some embodiments, the gain map can be a forward mapping from the first image to the second image. In some embodiments, the gain map can be a reverse mapping from the second image to the first image. An image specific global tone curve can be determined by curve fitting to the gain map scatter plot, and a residual gain map can be generated based on a comparison of the gain map to a reconstructed gain map derived from the image specific global tone curve.

An exemplary embodiment sets forth a method to generate an image specific global tone curve from a first image and a second image. The method can include: (1) obtaining a gain map based on a comparison between pixels (unit areas) of a first image to corresponding pixels (unit areas) of a second image, the gain map including a set of gain values for the pixels (unit areas) of the first and second images (2) generating a scatter plot comprising a set of points, each point including a gain value and a luma value, where luma values can be generated from corresponding channel values for pixels (unit areas) of a first image, and where the gain value represents a mapping between the pixel (unit area) of the first image to a corresponding pixel (unit area) of the second image (3) determining an image specific global tone curve based on curve fitting to the scatter plot using a cost function, and (4) storing the image specific global tone curve with the first image. In some embodiments, the method further includes: (5) generating a reconstructed gain map from the image specific global tone curve, and (6) determining a residual gain map based on a comparison between pixels (unit areas) of the reconstructed gain map and corresponding pixels (unit areas) of the gain map.

In some embodiments, the first and second images have different dynamic ranges of channel values (or different ranges of corresponding luma values). In some embodiments, an approximation of the second image can be constructed using the image specific global tone curve and the first image. In some embodiments, an exact replica of the second image can be constructed using the image specific global tone curve, the residual gain map, and the first image. In some embodiments, the image specific global tone curve comprises multiple contiguous segments, each segment corresponding to a polynomial function such as a cubic spline. In some embodiments, curve fitting constrains the image specific global tone curve to be a monotonically increasing function. In some embodiments, an approximation of the first image can be constructed using the image specific global tone curve and the second image. In some embodiments, an exact replica of the first image can be constructed using the image specific global tone curve, the residual gain map, and the second image.

Other embodiments include a non-transitory computer readable storage medium configured to store instructions that, when executed by at least one processor included in a computing device, cause the computing device to carry out the various steps of any of the foregoing methods. Further embodiments include a computing device that is configured to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates an overview of a computing device that can be configured to perform the various techniques described herein, according to some embodiments.

FIGS. 2A, 2B, 2C, 2D, and 2E illustrate a sequence of conceptual diagrams of a technique for generating an image specific global tone curve map based on a first (baseline) image and a second (alternate) image, according to some embodiments.

FIG. 2F illustrates a diagram of a technique for generating a residual gain map, according to some embodiments.

FIGS. 3A and 3B illustrates functional relationships between images, gain maps, scatter plots, and global tone curves, according to some embodiments.

FIG. 4 illustrates a flowchart of a representative method for generating an image specific global tone curve based on two images, according to some embodiments.

FIG. 5 illustrates a detailed view of a computing device that can be used to implement the various techniques described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments can be practiced without some or all of these specific details. In other instances, well-known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting such that other embodiments can be used, and changes can be made without departing from the spirit and scope of the described embodiments.

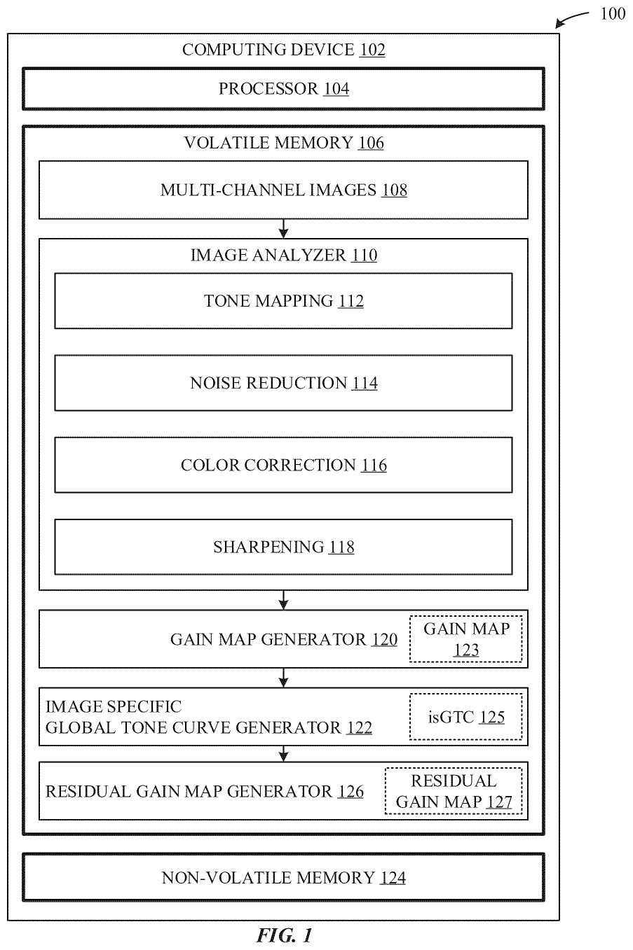

Representative embodiments set forth herein disclose techniques for generating gain maps based on acquired images. In particular, a gain map can be generated by comparing a first image to a second image. The gain map can then be embedded into the first image to enable the second image to be efficiently reproduced using the first image and the gain map. A more detailed description of these techniques is provided below in conjunction with FIGS. 1, 2A-2F, 3A, 3B, 4, and 5.

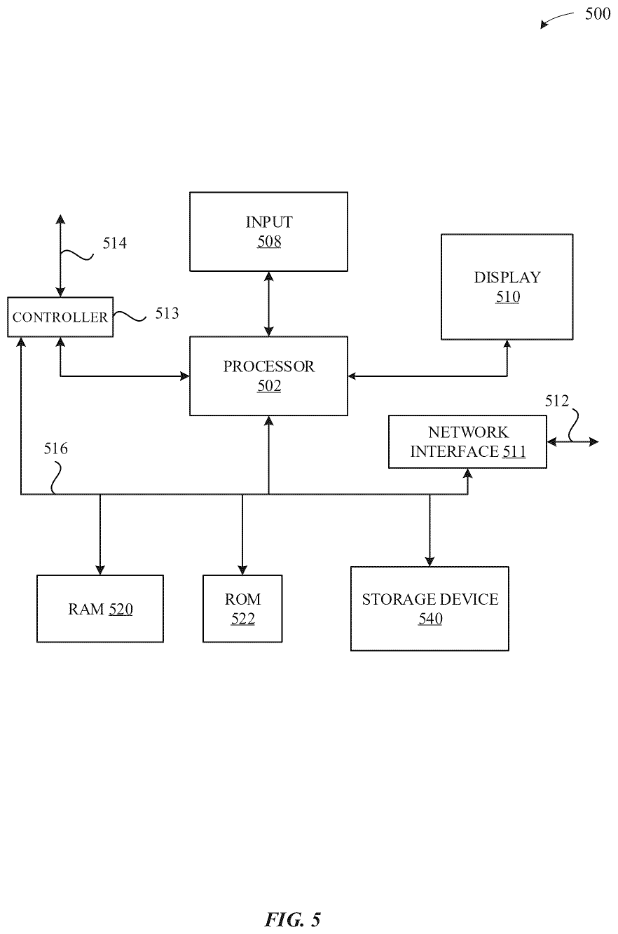

FIG. 1 illustrates an overview 100 of a computing device 102 that can be configured to perform the various techniques described herein. As shown in FIG. 1, the computing device 102 can include a processor 104, a volatile memory 106, and a non-volatile memory 124. It is noted that a more detailed breakdown of example hardware components that can be included in the computing device 102 is illustrated in FIG. 5, and that these components are omitted from the illustration of FIG. 1 merely for simplification purposes. For example, the computing device 102 can include additional non-volatile memories (e.g., solid-state drives, hard drives, etc.), other processors (e.g., a multi-core central processing unit (CPU)), a graphics processing unit (GPU), and so on). According to some embodiments, an operating system (OS) (not illustrated in FIG. 1) can be loaded into the volatile memory 106, where the OS can execute a variety of applications that collectively enable the various techniques described herein to be implemented. For example, these applications can include an image analyzer 110 (and its internal components), a gain map generator 120 (and its internal components), an image specific global tone curve generator 122, a residual gain map generator 126, one or more compressors (not illustrated in FIG. 1), and so on.

As shown in FIG. 1, the volatile memory 106 can be configured to receive multiple-channel images 108. The multiple-channel images 108 can be provided, for example, by a digital imaging unit (not illustrated in FIG. 1) that is configured to capture and process digital images. According to some embodiments, a multiple-channel image 108 can be composed of a collection of pixels, where each pixel in the collection of pixels includes a group of sub-pixels (e.g., a red sub-pixel, a green sub-pixel, a blue sub-pixel, an alpha sub-pixel, etc.). It is noted that the term “sub-pixel” used herein can be synonymous with the term “channel.” It is also noted that the multiple-channel images 108 can have different resolutions, layouts, bit-depths, and so on, without departing from the scope of this disclosure.

According to some embodiments, a first multiple-channel image 108 can represent a standard dynamic range (SDR) image that constitutes a single exposure of a scene that is gathered and processed by the digital imaging unit. A second multiple-channel image 108 can also represent a high dynamic range (HDR) image that constitutes multiple exposures of a scene that are gathered and processed by the digital imaging unit. To generate an HDR image, the digital imaging unit may capture a scene bracketed for different exposure values, e.g., three exposure values that can be referred to as “EV0”, “EV−”, and “EV+”. Generally, the EV0 image corresponds to a normal/ideal exposure for the scene (typically captured using auto-exposure settings of the digital imaging unit); the EV− image corresponds to an under-exposed image of the scene (e.g., four times darker than EV0), and the EV+ image corresponds to an over-exposed image of the scene (e.g., four times brighter than EV0). The digital imaging unit can combine the different exposures to produce a resultant image that incorporates a greater range of luminance relative to SDR images. It is noted that the multiple-channel images 108 discussed herein are not limited to SDR/HDR images. On the contrary, the multiple-channel images 108 can represent any form of digital image (e.g., scanned images, computer-generated images, etc.) without departing from the scope of this disclosure.

As shown in FIG. 1, the multiple-channel images 108 can (optionally) be provided to the image analyzer 110. According to some embodiments, the image analyzer 110 can include various components that are configured to process/modify the multiple-channel images 108, as well as generate information based thereon. For example, the image analyzer 110 can include a tone mapping unit 112 (e.g., configured to perform global/local tone mapping operations, inverse tone mapping operations, etc.), a noise reduction unit 114 (e.g., configured to reduce global/local noise in the multiple-channel image), a color correction unit 116 (e.g., configured to perform global/local color corrections in the multiple-channel image), and a sharpening unit 118 (e.g., configured to perform global/local sharpening corrections in the multiple-channel image). It is noted that image analyzer 110 is not limited to the aforementioned processing units, and that the image analyzer 110 can incorporate any number of processing units, configured to perform any processing of/modifications to the multiple-channel images 108, without departing from the scope of this disclosure.

As shown in FIG. 1, the multiple-channel images 108 can be provided to the gain map generator 120 after being processed by the image analyzer 110. However, it is noted that the multiple-channel images 108 can bypass the image analyzer 110 and be provided to the gain map generator 120, if so desired, without departing from the scope of this disclosure. It is also noted that the multiple-channel images 108 can bypass one or more of the processing units of the image analyzer 110 without departing from the scope of this disclosure. For example, two given multiple-channel images may be passed through the tone mapping unit 112 to receive local tone mapping modifications, and then bypass the remaining process units in the image analyzer 110. In this regard, the two multiple-channel images—which have undergone local tone mapping operations—can be utilized to generate a gain map 123 that reflects the local tone mapping operations that were performed.

In any case—and, as described in greater detail herein—the gain map generator 120 can, upon receiving two multiple-channel images 108, generate a gain map 123 based on the two multiple-channel images 108. According to some embodiments, the gain map 123 can be used to generate a scatter plot from which an image specific global tone curve (isGTC) 125 can be derived by an image specific global tone curve generator 122. In some embodiments, the scatter plot can be parameterized using i) gain values from unit areas (individual pixels or groups of pixels) of the gain map 123, and ii) channel values from corresponding unit areas of one of the two multi-channel images 108, e.g., a first (baseline) multi-channel image. Each point (dot) in the scatter plot is associated with a particular gain value and a particular channel value, e.g., a luminance channel value. Multiple unit areas of the gain map and corresponding multiple unit areas of the multi-channel image can have the same particular gain value and particular channel value. Each point in the scatter plot can therefore include a count (or normalized) count of unit areas that have that particular gain value and particular channel value. Unit areas of a multi-channel image 108 can be individual pixels of the multi-channel image 108 or represent groups of contiguous pixels of the multi-channel image 108, e.g., groups of four adjacent pixels.

Accordingly, the gain map scatter plot can be characterized by counts of channel value and gain value pairs that occur in unit areas. Alternatively, the scatter plot can be based on a plot of channel values from each of two multi-channel images 108 for corresponding unit areas, e.g., a plot of channel values for unit areas of a first multi-channel image 108 against channel values for corresponding unit areas of a second multi-channel image 108. The isGTC 125 can be derived by determining a curve that fits (e.g., based on optimizing a cost function) to the scatter plot. In some embodiments, the isGTC 125 can consist of contiguous piece-wise segments, where each segment is characterized by a polynomial function, e.g., a cubic spline. According to some embodiments, an approximation of the second multi-channel image 108 can be derived from the first multi-channel image 108 using the isGTC 125. A residual gain map generator 126 can determine a residual gain map 127 by comparing a reconstructed gain map derived from the isGTC 125 to the gain map 123 previously determined. A replica of the second multi-channel image 108 can be derived from the first multi-channel image 108 using the isGTC 125 together with the residual gain map 127.

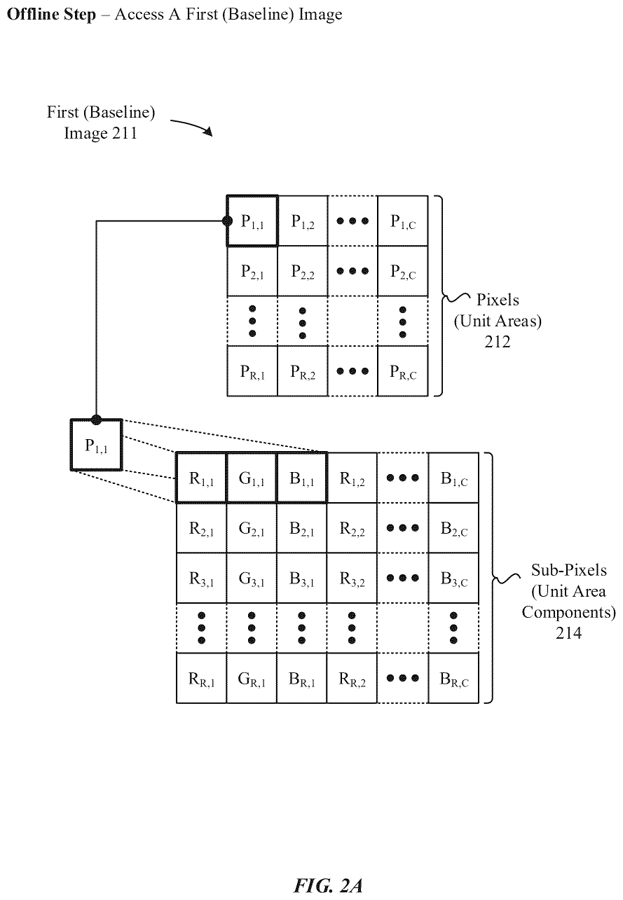

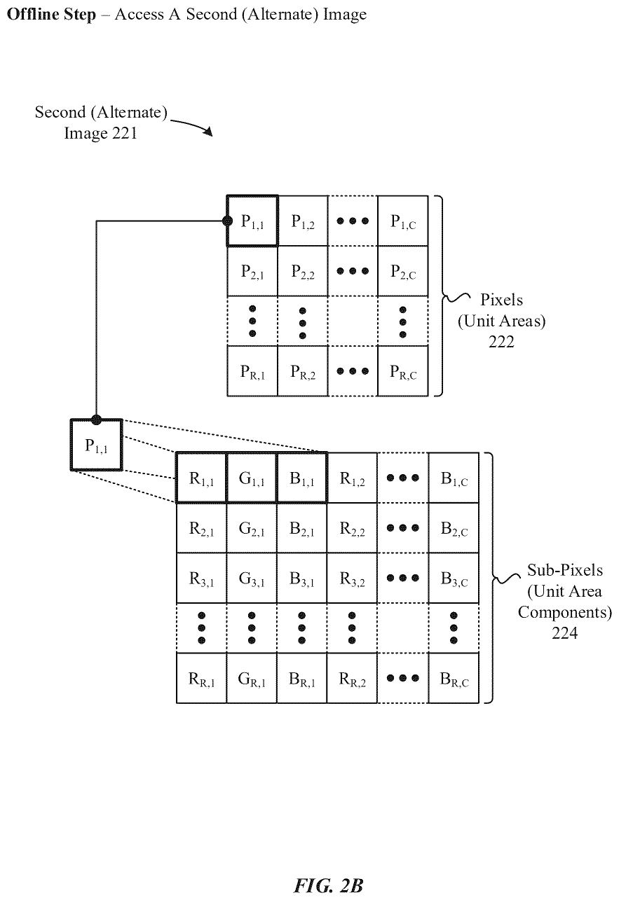

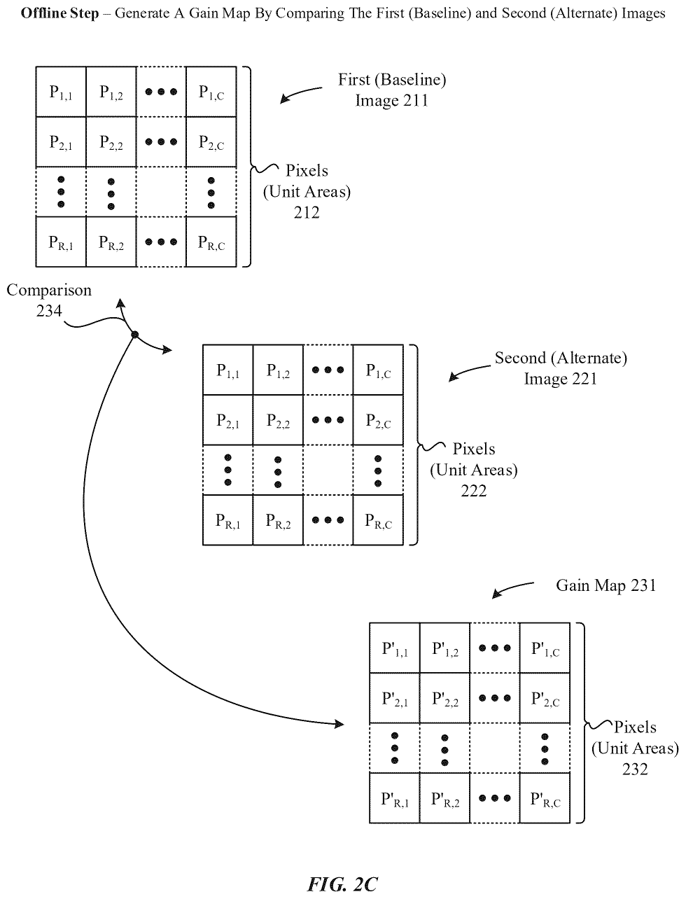

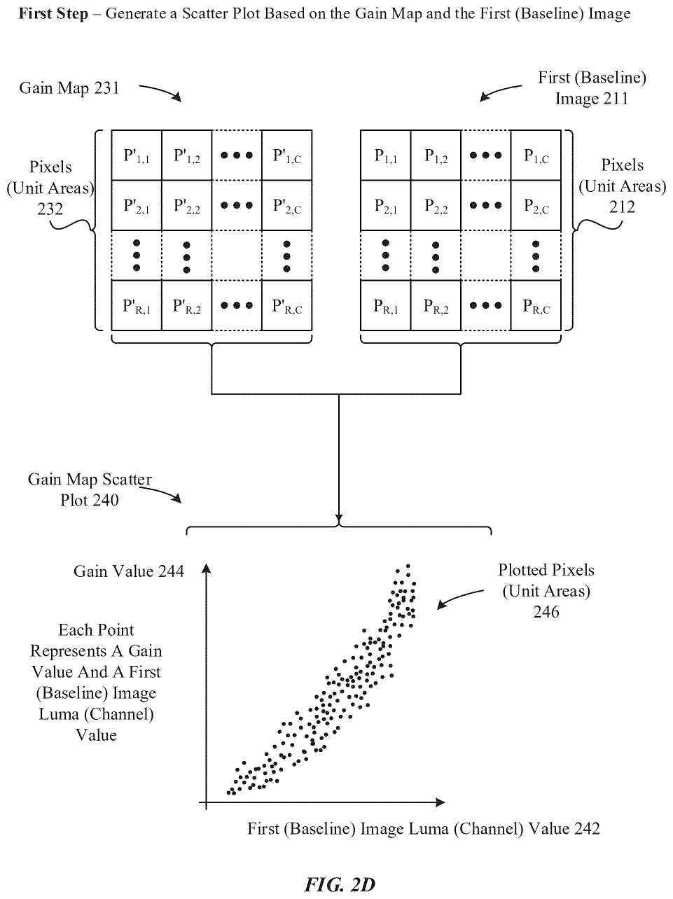

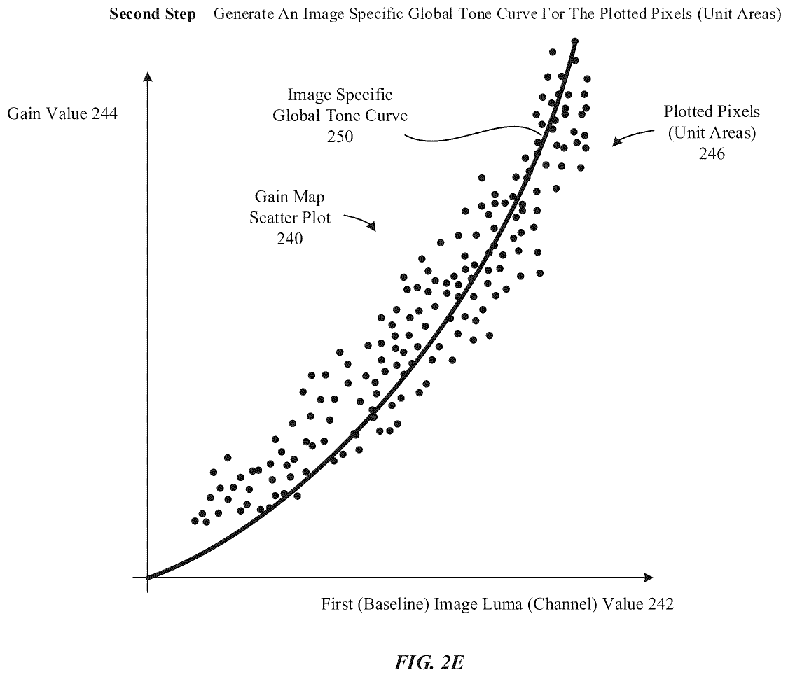

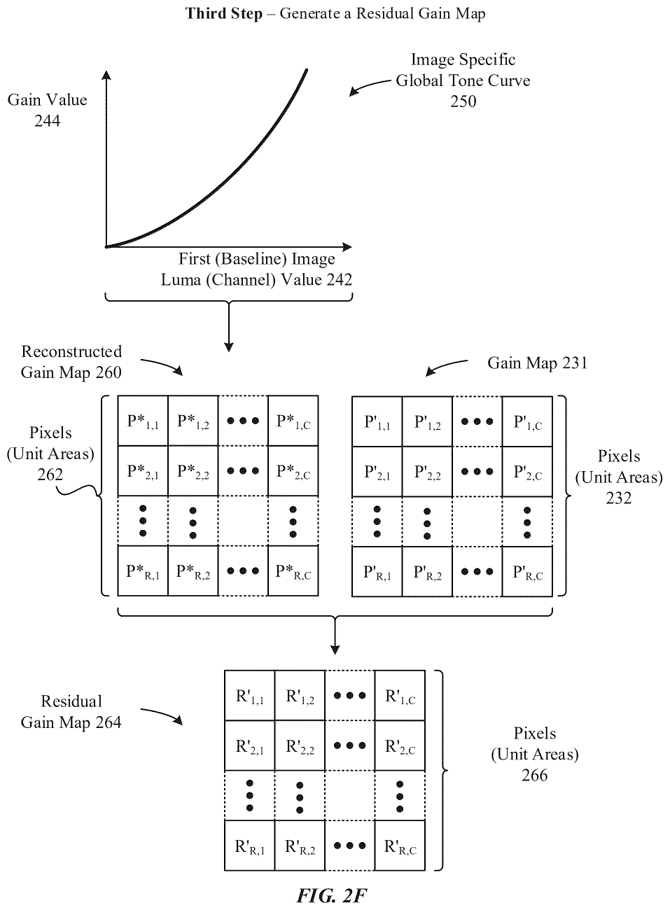

Accordingly, FIG. 1 provides a high-level overview of different hardware/software architectures that can be implemented by computing device 102 in order to carry out the various techniques described herein. A more detailed breakdown of these techniques will now be provided below in conjunction with FIGS. 2A-2F, and 3-4.

FIGS. 2A-2F illustrate a sequence of conceptual diagrams of a technique for generating an image specific global tone curve 125 and a residual gain map 264 based on a first (baseline) image 211 and a second (alternate) image 221, according to some embodiments. The steps outline in FIGS. 2A, 2B, and 2C can occur “offline”, i.e., the steps to generate a gain map 123 can occur separately from the subsequent steps to generate the image specific global tone curve, which can be generated using a supplied gain map that is associated with a pair of images. As shown in FIG. 2A, a first offline step can involve the computing device 102 accessing a first (baseline) image 211, which is composed of pixels 212 (each denoted as “P”). More generally, the first (baseline) image 211 can be composed of unit areas that include one or more contiguous pixels. For example, a unit area can include four adjacent square pixels that form a larger square or can be a composite “larger” pixel derived from multiple adjacent “smaller” pixels. As shown in FIG. 2A, the pixels 212 can be arranged according to a row/column layout, where the subscript of each pixel 212 “P” (e.g., “1,1”) indicates the location of the pixel 212 in accordance with the rows and columns. The pixels 212 of the first (baseline) image 211 can be arranged in an equal number of rows and columns, such that the first (baseline) image 211 is a square image. However, it should be appreciated that the techniques described herein can be applied to multiple-channel images 108 having different layouts (e.g., disproportionate row/column counts), i.e., the number of rows “R” can differ from the number of columns “C” for the first (baseline) image 211. As shown in FIG. 2A, each pixel 212 can be composed of three sub-pixels 214-a red sub-pixel 214 (denoted “R”), a green sub-pixel 214 (denoted “G”), and a blue sub-pixel 214 (denoted “B”). More generally, the sub-pixels 214 can be considered as component values of unit areas. It is noted, however, that each pixel 212 can be composed of any number of sub-pixels 214 without departing from the scope of this disclosure.

FIG. 2B illustrates a second offline step that involves the computing device 102 accessing a second (alternate) image 221. As shown in FIG. 2B, the second (alternate) image 221 is composed of pixels 222, or more generally unit areas, (and sub-pixels 224, or more generally unit area components) similar to the pixels 212 (and sub-pixels 214) of the first (baseline) image 211 illustrated in FIG. 2A. In some embodiments, the first (baseline) image is a standard dynamic range (SDR) image and the second (alternate) image 221 is a high dynamic range (HDR) image. In some embodiments, the first (baseline) image is an HDR image and the second (alternate) image 221 is an SDR image. In some embodiments, the second (alternate) image 221 is a modification (e.g., photographically edited) version of the first (baseline) image 211. In some embodiments, the first (baseline) image 211 is a single-exposure capture of the same scene captured by the second (alternate) image 221 derived from multiple captures at different exposures, such that the first (baseline) image 211 and the second (alternate) image 221 are substantially related to one another. For example, if the second (alternate) image 221 is generated using bracketed images at EV−, EV0, and EV+ settings as discussed herein, then the first (baseline) image 211 can be based on the EV0 exposure (e.g., prior to the EV0 exposure being merged with the EV− and the EV+ exposures to generate the second (alternate) image 221). The pixels of the first (baseline) image 211 and the second (alternate) image 221 may differ in channel values, such as luminance levels, and/or capture variations in color values for the pixels.

FIG. 2C illustrates a third offline step that involves the computing device 102 generating a gain map 231 (composed of pixels 232, or more generally unit areas) by comparing pixels (unit areas) of the first (baseline) image 211 and pixels (unit areas) of the second (alternate) image 221 (illustrated in FIG. 2C as the comparison 234). In some embodiments, a channel value for each pixel (or composite channel value for each unit area) of the second (alternate) image 221 is divided by the channel value (or composite channel value for a unit area) of the corresponding pixel (or unit area) of the first (baseline) image 211 to produce a quotient. In turn, the respective quotients can be assigned to the values of the corresponding pixels 232 (unit areas) of the gain map 231. For example, if the pixel denoted “P_{1,1}” of the first (baseline) image 211 has a value of “5”, and the pixel denoted “P_{1,1}” of the second (alternate) image 221 has a value of “1”, then the quotient would be “0.2”, and would be assigned to the value of the pixel denoted “P_{1,1}” of gain map 231. In this manner, the pixel denoted “P_{1,1}” of the second (alternate) image 221 could be reproduced by multiplying the pixel denoted “P_{1,1}” of the first (baseline) image 211 (having a value of “5”) by the pixel denoted “P_{1,1}” of gain map 231 (having a value of “0.2”). In particular, the multiplication would generate a product of “1”, which matches the value “1” of the pixel denoted “P_{1,1}” of the second (alternate) image 221. Accordingly, the gain map 231 and the first (baseline) image 211 can be used to generate a replica of the second (alternate) image 221. Alternatively, channel values for pixels (or composite channel values for unit areas) of the first (baseline) image 211 can be divided by channel values (or composite channel values for unit areas) of the second (alternate) image 221 to create an inverse gain map.

As a brief aside, it is noted that although the comparisons illustrated in FIG. 2C (and described herein) constitute pixel-level comparisons, the embodiments are not so limited. On the contrary, the pixels of the images can be compared to one another, at any level of granularity, without departing from the scope of this disclosure. For example, the sub-pixels of the first (baseline) image 211 and the sub-pixels of the second (alternate) image 221 can be compared to one another (instead of or in addition to pixel-level comparisons) such that multiple gain maps can be generated under different comparison approaches (e.g., a respective gain map for each channel of the image). In some embodiments, luminance values for each pixel representing a brightness level of the pixel and combining values of sub-pixels of different color channels (or available from a monochromatic image) can be compared between first (baseline) and second (alternate) images to determine a luminance gain map.

Additionally, it is noted that various optimizations can be employed when generating the gain maps, without departing from the scope of this disclosure. For example, when two values are identical to one another, the comparison operation can be skipped, and a single bit value (e.g., “0”) can be assigned to the corresponding value in the gain map to minimize the size of (i.e., storage requirements for) the gain map. Additionally, the resolution of a gain map can smaller than the resolution of the images that are compared to generate the gain map. For example, an approximation of every four pixels in a first image can be compared against an approximation of every four corresponding pixels in a second image in order to generate a gain map that is one quarter of the resolution of the first and second images. This approach would substantially reduce the size of the gain map but would lower the overall accuracy by which the first image can be reproduced from the second image and the gain map (or vice versa). Additionally, first and second images can be resampled in any conceivable fashion prior to generating a gain map. For example, the first and second images could undergo local tone mapping operations prior to generating a gain map.

FIG. 2D illustrates a first step to produce an image specific global tone curve, where the first step involves the computing device 102 generating an exemplary scatter plot, e.g., a gain map scatter plot 240, using values of the gain map 231 and luma (channel) values from the first (baseline) image 211. Each pixel (unit area) 212 of the first (baseline) image 211 can have one or more channel values associated with the pixel (unit area) 212. For example, a pixel P_{1,1} (unit area) 212 of the first (baseline) image 211 can have a red color channel value R_{1,1}, a green color channel value G_{1,1}, a blue color channel value B_{1,1}, a luminance value L_{1,1} (not explicitly shown, but which can represent a brightness level of the pixel P_{1,1} when combining together the color channel values of the sub-pixels of the pixel P_{1,1}). In the ensuing discussion, luminance values for pixels are used to generate a scatter plot, e.g., the gain map scatter plot 240; however, a single-color channel value or other combinations of color channel values for each pixel can also be considered. Multiple pixels of the first (baseline) image 211 can have the same channel value, e.g., an identical (or quantized to an identical) luminance value. Gain values of pixels of the gain map 231 that correspond to the multiple pixels for a given channel value may vary. Each pixel pair, consisting of a pixel P_{i,j} of the first (baseline) image 211 and a corresponding pixel P′_{i,j} of the gain map 231, can be characterized by a particular first (baseline) image channel value 242 and a particular gain value 244. Each pixel pair can be plotted on the gain map scatter plot 240, where the x-axis represents the first (baseline) image channel value 242 and the y-axis represents the gain value 244. Distinct pixel pairs at different areas of the first (baseline) image 211 and gain map 231 can have the same first (baseline) image channel value 242 and gain value 244. Thus, a single point of the gain map scatter plot 240, which has a particular first (baseline) image channel value and a particular gain value 244, can represent a count of pixel pairs that have those particular paired values. In some embodiments, the count values associated with the plotted points of the gain map scatter plot 240 can be normalized to a particular range (e.g., from 0 to 1).

The gain map scatter plot 240 illustrated in FIG. 2D is based on pairs of gain values 244 from the gain map 231 and first (baseline) image channel values 242. Alternative pairs of values can also be used to generate a scatter plot. For example, first (baseline) image channel values 242 can be paired with corresponding channel values from the second (alternate) image 221 to produce a scatter plot based on first (baseline) image channel values along 242 the x-axis and second (alternate) image channel values along the y-axis. In some embodiments, the first (baseline) image 211 is an SDR image and the second (alternate) image 221 is an HDR image, and the scatter plot represents (SDR, HDR) channel value pairs. In some embodiments, the first (baseline) image 211 is an HDR image and the second (alternate) image 221 is an SNR image, and the scatter plot represents (HDR, SDR) channel value pairs. In some embodiments, gain map values 244 are paired with channel values from the second (alternate) image 221 to generate a scatter plot. The gain map 231 can be considered a function of the first (baseline) image 211 and the second (alternate) image 221, and other functions can also be considered to create alternatives to gain maps that can be then used to generate a scatter plot.

It should be noted that while the techniques described in conjunction with FIG. 2D (as well as other drawings) effectively treat each pixel with equal weight, the embodiments are not so limited. On the contrary, various analyses, adjustments, etc., can be performed to identify and assign weights against pixels to affect the manner in which the scatter plot itself—as well as information that is ultimately derived from the gain map scatter plot 240 (e.g., image-specific global tone curves, (reconstructed, residual, etc.) gain maps, etc.)—is generated. In particular, and according to some embodiments, respective weights can be assigned to one or more unit areas (pixels, groups of pixels, etc.) of an image that are of particular interest, such as an object within the image, a region (uniform/uniform in shape) within the image, and so on. For example, one or more weights can be applied to a group of pixels that correspond to a person's face within a given image. In another example, one or more weights can be applied to a group of pixels that correspond to an automobile within a given image. In yet another example, one or more weights can be applied to a group of pixels that correspond to the sky within a given image. In any case, the application of such weights to the group of pixels—which can effectively increase (e.g., areas of interest) or decrease (e.g., areas of non-interest) one or more channel values of the pixels—can also affect the layout of the gain map scatter plot 240. Consequently—and, as described in greater detail below—the information that is generated based on the (resultantly adjusted) gain map scatter plot 240 is influenced/adjusted as well.

It is noted that any approach can be utilized to identify the aforementioned regions, objects, etc., within an image that may be of interest, including non-artificial intelligence approaches (e.g., SIFT (Scale-Invariant Feature Transform), SURF (Speeded-Up Robust Features), ORB (Oriented FAST and Rotated BRIEF), Harris Corner Detector, Histogram-Based Matching, Template Matching, Edge Detection (e.g., Canny Edge Detector), Color-based Segmentation, Morphological Operations, Connected Component Analysis, Texture Analysis, etc.), artificial intelligence approaches (Haar Cascades, Convolutional Neural Networks (CNNs), Region-based CNNs (R-CNN, Fast R-CNN, Faster R-CNN), YOLO (You Only Look Once), SSD (Single Shot Multibox Detector), Mask R-CNN, K-means Clustering, Histogram of Oriented Gradients (HOG), Edge Detection (e.g., Canny Edge Detector), Mean-Shift Clustering, etc.), user-input based approaches (e.g., user-provided bounding boxes), and so on, without departing from the scope of this disclosure. It is additionally noted that the aforementioned weights can be identified using any of the foregoing approaches, without departing from the scope of this disclosure. It is additionally noted that respective weights can be applied to individual pixels, groups of pixels, etc., at any level of granularity, without departing from the scope of this disclosure.

Statistical information of the gain map scatter plot 240 can also be generated to use in determining a curve to fit to the gain map scatter plot 240. For each particular channel value, e.g., a particular luma value, in the first (baseline) image 211, there may be multiple individual pixels (unit areas) of the first (baseline) image 211 that have that particular channel value. The gain values 244 of the pixels (unit areas) of the gain map 231 that correspond to the multiple individual pixels (unit areas) of the first (baseline) image 211 may span a range of gain values 244. Several plotted pixels (unit areas) 246 in the gain map scatter plot 240 can have a particular first (baseline) image luma (channel) value 242 and have different gain values 244. Thus, a particular first (baseline) image luma (channel) value 242 can be associated with a set of gain values 244, for which statistics, such as mean, standard deviation, percentile, etc. can be generated. The pairs of values for pixels (unit areas) in the gain map 231 can be processed in various manners to generate statistical values that can be used to assist with generating an image specific global tone curve to fit to the gain map scatter plot 240 data. According to some embodiments, a different statistical probability function for each first (baseline) image luma (channel) value 242 can be derived and used, in some embodiments, to characterize the gain map scatter plot 240, e.g., to assist in deriving a curve to fit to the gain map scatter plot 240. In some embodiments, one or more statistical histograms and/or probability density functions are determined based on the gain map scatter plot 240 data, and can be used to estimate an image specific global tone curve 250 to fit to the gain map scatter plot 240 data.

FIG. 2E illustrates a second step in which an image specific global tone curve 250 is generated from the plotted pixels (unit areas) 246 of the gain map scatter plot 240. The image specific global tone curve 250 can be determined using one or more model fitting methods, such as: i) polynomial fit, ii) parametric fit with a generalized logistic function, sigmoid, tanh, etc., iii) multi-layer pyramid, iv) piecewise linear fit, piecewise cubic spline, pchip, makima, v) look up table (LUT) with midpoints set to a certain percentile and linear interpolation between midpoints, vi) LUT derived via a curve fit, and/or vii) multiple stages: coarse LUT followed by cubic spline/pchip/makima followed by finer LUT. Various cost functions can be used to determine the best curve fit, such as based on: i) square or root square distance, ii) structural similarity index measure (SSIM), iii) variance inflation factor (VIF), and/or iv) statistical metrics (mean, median, maximum, percentile, etc.). In some embodiments, one or more heuristic rules are applied to determine the best curve fit, where the heuristic rules are selected to improve image quality of an image that can result from using the image specific global tone curve 250. Exemplary heuristic rules can include: i) limiting negative slope values of the image specific global tone curve 250 for higher channel values (e.g., higher luma or luminance values) and/or after a peak of the image specific global tone curve 250 occurs, ii) ensuring continuity and/or smoothness of the image specific global tone curve 250, iii) detecting and compensating for multi-modal distributions of data, iv) adjusting weighting factors for multi-modal data distributions and/or for data with large variance values, v) adjusting for pixels (unit areas) with empty values.

The image specific global tone curve 250 effectively combines local tone curve information for different regions of the first (baseline) image 211 and second (alternate) image 221 together. Different optimization algorithms that incorporate various rules (including in some cases heuristic rules) can result in different image specific global tone curves 250 that vary in their properties. For example, one approach can produce an image specific global tone curve 250 that more closely matches to brighter areas (higher luminance values) of the images, while another approach can produce an image specific global tone curve 250 that more closely matches to darker areas (lower luminance values) of the images. In some embodiments, options for tuning the algorithms to determine the image specific global tone curve 250 can be implemented, such as to allow for generation of an image specific global tone curve 250 that more closely matches a desired result, e.g., biased toward a brighter image or biased toward a darker image.

In some embodiments, options for selection of an image type, e.g., indoor portrait vs outdoor landscape, can be used to determine particular parameters to use in model fitting to produce the image specific global tone curve 250. In some cases, multiple image specific global tone curves 250 can be provided, each with different properties to allow for subsequent selection based on a user-determined preference. In general, the image specific global tone curves 250 include less information than the gain map 231 from which they are derived and can require less storage. With judicious selection of optimization algorithms, images generated using the limited information of the image specific global tone curve 250 instead of the full information in the gain map 231 can perceptibly be minimally different. The image specific global tone curve 250 therefore provides a more efficient representation of a difference between two images. In some cases, the image specific global tone curve 250 can be represented by a set of coefficients and/or parameter values for one or more functions. In some cases, the image specific global tone curve 250 can be represented as a look up table (LUT) of values.

FIG. 2F illustrates a third step in which a residual gain map 264 is generated using the image specific global tone curve 250 and the gain map 231 derived from the comparison of the first (baseline) image 211 and the second (alternate) image 221. The image specific global tone curve 250 can be used to determine a reconstructed gain map 260 that includes gain values for each pixel (unit area) 262 across the images 211/221. As generation of the image specific global tone curve 250 is not a lossless process (i.e., local information is lost in generating the image specific global tone curve 250), the reconstructed gain map 260 will differ from the gain map 231 derived directly from the images 211/221. The reconstructed gain map 260 and the gain map 231 can be compared to each other to determine the residual gain map 264, which includes values for individual pixels (unit areas) 266. For example, a difference can be determined between each pixel (unit area) 262 of the reconstructed gain map 260 and the corresponding pixel (unit area) 232 the gain map 231 to calculate a residual gain map 264 value of the pixel (unit area) 266 of the residual gain map 264. The gain map 231 can be used to generate an exact copy of the second (alternate) image 221 from the first (baseline) image 211. (The gain map 231 can also be used to generate an exact copy of the first (baseline) image 211 from the second (alternate) image 221 by applying inverse gain values appropriately to generate the second (alternate) image 221 from the first (baseline) image 211.) The image specific global tone curve 250 can be used, e.g., via the reconstructed gain map 260, to produce a variant of the second (alternate) image 221 from the first (baseline) image 211. The residual gain map 264 captures the difference between the “full information” gain map 231 and the “reduced information” reconstructed gain map 260 generated from the image specific global tone curve 250. In some embodiments, the residual gain map 264 can be stored along with the image specific global tone curve 250 to allow for reproducing an exact replica of the second (alternate) image 221 from the first (baseline) image 211. In some embodiments, the residual gain map 264 and the image specific global tone curve 250 can be used to reproduce an exact replica of the first (baseline) image 211 from the second (alternate) image 221, inverting gain values appropriately when applying them.

As a brief aside, it is noted that while FIGS. 2D-2F discuss the generation of a single image specific global tone curve 250 for a given image, the embodiments are not so limited. On the contrary, any number of image specific global tone curves 250, at any level of granularity, can be generated for a given image, without departing from the scope of this disclosure. For example, two or more areas of a given image—such as objects, regions (uniform/uniform in shape), etc.,—can be identified (e.g., using the non-AI, AI, user-input, etc., approaches discussed herein), and then the techniques described in conjunction with FIGS. 2D-2F can be carried out against each area of the two or more areas to generate a respective image specific global tone curves 250 for the area. Each image specific global tone curves 250 can then be paired with information that identifies the respective areas of the image to which the image specific global tone curve 250 corresponds, and then can be stored along with the image. In this manner, the image specific global tone curves 250 can enable respective adjustments to be made to the areas, where appropriate, when the image is being displayed.

Additionally, it is noted that enhanced features can be provided when a given image is associated with two or more image specific global tone curves 250, such as when multiple image specific global tone curves 250 are generated for different areas of the image, when two or more versions of an image specific global tone curve 250 are generated for a given area of the image, and so on. For example, user interfaces can be provided that enable any of the image specific global tone curves 250 to be applied to their respective corresponding areas within the image. Moreover, the user interfaces can enable any of the image specific global tone curves 250 to be adjusted based on any amount, type, form, etc., of information, at any level of granularity, without departing from the scope of this disclosure. This flexibility can beneficially enable end-users to view the effects of the image specific global tone curves 250 when they are applied against the image, the effects of any adjustments to the image specific global tone curves 250 when they are applied against the image, and so on.

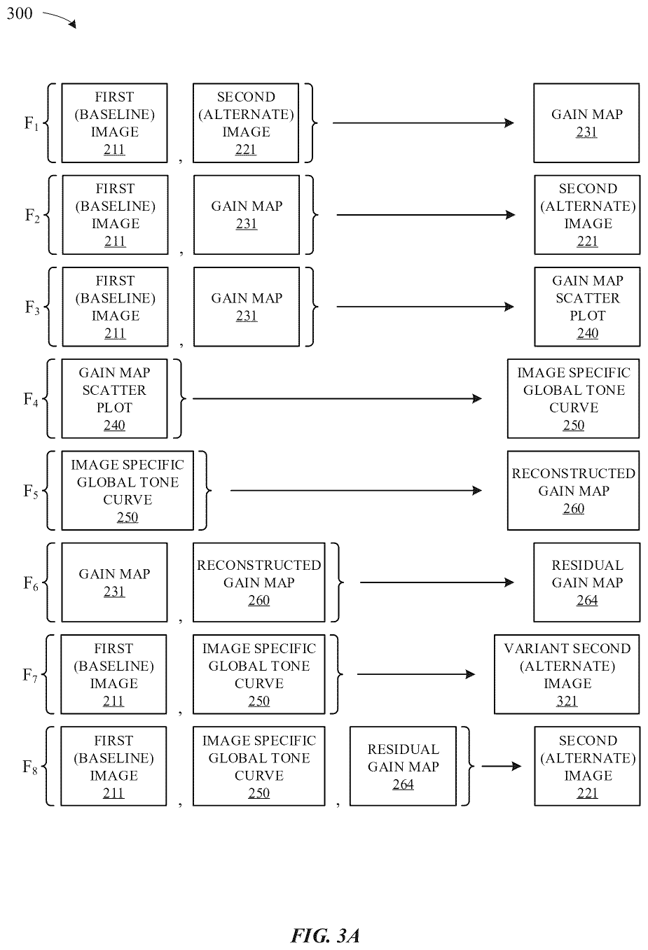

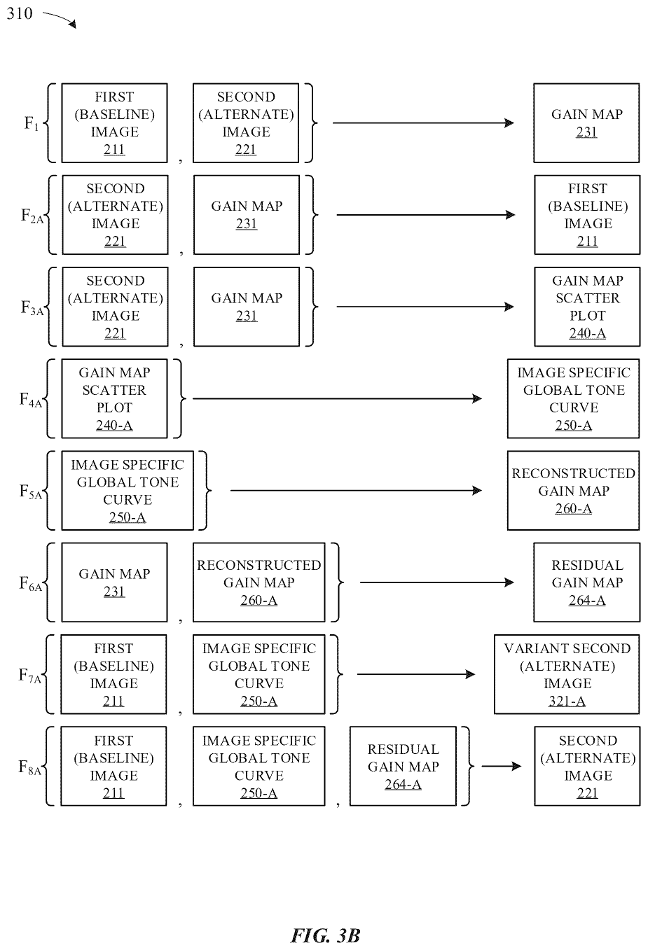

FIG. 3A illustrates a diagram 300 representing the functional relationships between various components discussed hereinabove. The gain map 231 can be generated as an output of a first function F₁ that takes the first (baseline) image 211 and the second (alternate) image 221 as inputs. The gain map 231 captures a comparison between the first (baseline) image 211 and the second (alternate) image 221. The second (alternate) image 221 can be regenerated as an output of a second function F₂ that takes the first (baseline) image 211 and the gain map 231 as inputs. A third function F₃ can be used to generate the gain map scatter plot 240 using the first (baseline) image 211 and the gain map 231 as inputs. In some cases, the gain map scatter plot 240 contains less information than the gain map 231. A fourth function F₄ can be used to generate the image specific global tone curve 250 from the gain map scatter plot 240. The fourth function F₄ is not a lossless operation, and the image specific global tone curve 250 contains less information than the full gain map 231. A fifth function F₅ can be used to generate a reconstructed gain map 260 from the image specific global tone curve 250. As the image specific global tone curve 250 does not capture the full information of the gain map 231, the reconstructed gain map 260 also does not capture the full information of the gain map 231. A sixth function F₆ can be used to generate a residual gain map 264 using the reconstructed gain map 260 and the gain map 231 as inputs. A seventh function F₇ can be used to create a variant version of the second (alternate) image 321 from the first (baseline) image 211 and the image specific global tone curve 250. In some cases, the first (baseline) image 211 is modified using a reconstructed gain map 260 obtained from the image specific global tone curve 250 to generate the variant version of the second (alternate) image 321. An eighth function F₈ can be used to generate an exact replica of the second (alternate) image 221 using the first (baseline) image 211, the image specific global tone curve 250, and the residual gain map 264 together as inputs.

FIG. 3B illustrates a diagram 310 representing alternative functional relationships between various components discussed hereinabove. As in FIG. 3A, the gain map 231 can be generated as an output of a first function F₁ that takes the first (baseline) image 211 and the second (alternate) image 221 as inputs. The gain map 231 captures a comparison between the first (baseline) image 211 and the second (alternate) image 221. The first (baseline) image 211 can be regenerated as an output of an alternate second function F_{2A} that takes the second (alternate) image 221 and the gain map 231 as inputs. The gain map values can be inverted when applying them to unit areas of the second (alternate) image to generate the first (baseline) image. A third alternate function F_{3A} can be used to generate an alternate gain map scatter plot 240-A using the second (alternate) image 221 and the gain map 231 as inputs. In some cases, the gain map scatter plot 240 contains less information than the gain map 231. A fourth alternate function F_{4A} can be used to generate an alternate image specific global tone curve 250-A from the alternate gain map scatter plot 240-A. The fourth alternate function F_{4A} is not a lossless operation, and the alternate image specific global tone curve 250-A contains less information than the full gain map 231. A fifth alternate function F_{5A} can be used to generate an alternate reconstructed gain map 260-A from the alternate image specific global tone curve 250-A. As the alternate image specific global tone curve 250-A does not capture the full information of the gain map 231, the alternate reconstructed gain map 260-A also does not capture the full information of the gain map 231. A sixth alternate function F_{6A} can be used to generate an alternate residual gain map 264-A using the alternate reconstructed gain map 260-A and the gain map 231 as inputs. A seventh alternate function F_{7A} can be used to create another variant version of the second (alternate) image 321-A from the first (baseline) image 211 and the alternate image specific global tone curve 250-A. In some embodiments, the first (baseline) image 211 is modified using the alternate reconstructed gain map 260-A obtained from the alternate image specific global tone curve 250-A to generate the additional variant version of the second (alternate) image 321-A. An eighth alternate function F_{8A} can be used to generate an exact replica of the second (alternate) image 221 using the first (baseline) image 211, the alternate image specific global tone curve 250-A, and the alternate residual gain map 264-A together as inputs. When applicable gain map values can be inverted as required to map between different first (baseline) and second (alternate) images, for example when the gain map is generated from the first (baseline) image to the second (alternate) image, inverse values of the gain map can be used to generate the first (baseline) image from the second (alternate) image.

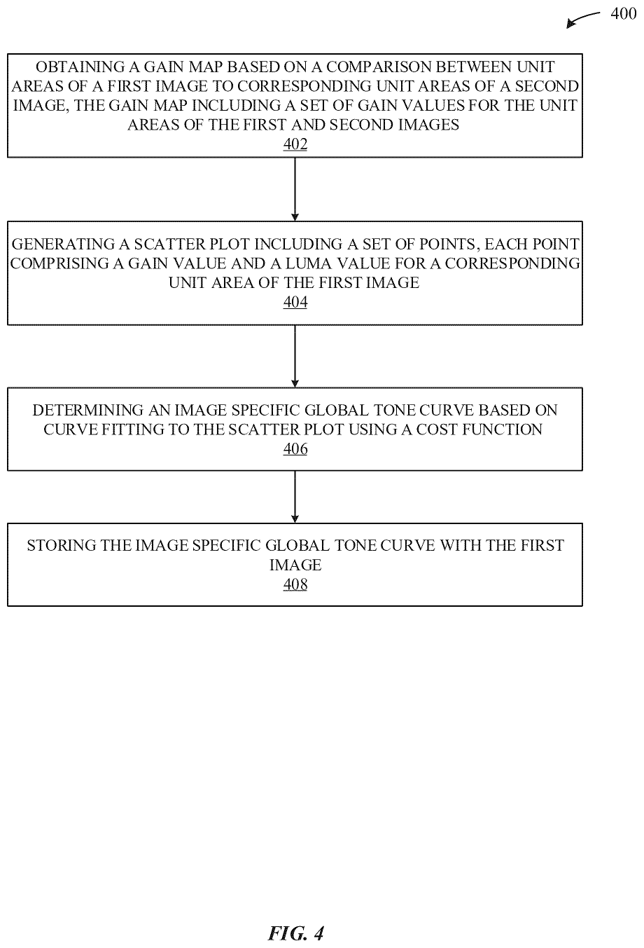

FIG. 4 illustrates a flow diagram 400 of an exemplary method to generate an image specific global tone curve 250 by a computing device (e.g., the computing device 102 of FIG. 1). At step 402, the computing device obtains a gain map that includes a set of gain values based on on a comparison of unit areas of a first image and unit areas of a second image. At step 404, the computing device generates a scatter plot including a set of points, each point including a gain value of the gain map and a luma (channel) value for a corresponding unit area of the first image (or of the second image). At step 406, the computing device determines the image specific global tone curve based on curve fitting to the scatter plot using a cost function. At step 408, the computing device stores the image specific global tone curve with the first image.

In some embodiments, the method further includes the computing device: i) generating a reconstructed gain map from the image specific global tone curve, and ii) determining a residual gain map based on a comparison between unit areas of the reconstructed gain map and corresponding unit areas of the gain map. In some embodiments, the second image is replicable using a combination of the first image, the image specific global tone curve, and the residual gain map. In some embodiments, the residual gain map includes a difference between gain values of unit areas of the reconstructed gain map and gain values of corresponding unit areas of the gain map. In some embodiments, the first image is a standard dynamic range (SDR) image, and the second image is a high dynamic range (HDR) image. In some embodiments, the method further includes the computing device generating a variant second image based on the first image and the image specific global tone curve, where the variant second image differs from the second image in one or more channel values of corresponding unit areas. In some embodiments, image specific global tone curve includes multiple contiguous segments, each segment corresponding to a cubic spline. In some embodiments, the curve fitting constrains the image specific global tone curve to be a monotonically increasing function. In some embodiments, the cost function includes one of: a least squares function, a structural similarity index measure (SSIM), or a variance inflation factor (VIF). In some embodiments, channel values of the first image used to generate the scatter plot include luminance values of unit areas of the first image. In some embodiments, channel values of the first image used to generate the scatter plot include one or more color values of unit areas of the first image. In some embodiments, each unit area corresponds to a single pixel. In some embodiments, each unit area corresponds to a plurality of contiguous pixels.

FIG. 5 illustrates a detailed view of a computing device 500 that can be used to implement the various techniques described herein, according to some embodiments. In particular, the detailed view illustrates various components that can be included in the computing device 102 described in conjunction with FIG. 1. As shown in FIG. 5, the computing device 500 can include a processor 502 that represents a microprocessor or controller for controlling the overall operation of the computing device 500. The computing device 500 can also include a user input device 508 that allows a user of the computing device 500 to interact with the computing device 500. For example, the user input device 508 can take a variety of forms, such as a button, keypad, dial, touch screen, audio input interface, visual/image capture input interface, input in the form of sensor data, and so on. Still further, the computing device 500 can include a display 510 that can be controlled by the processor 502 (e.g., via a graphics component) to display information to the user. A data bus 516 can facilitate data transfer between at least a storage device 540, the processor 502, and a controller 513. The controller 513 can be used to interface with and control different equipment through an equipment control bus 514. The computing device 500 can also include a network/bus interface 511 that couples to a data link 512. In the case of a wireless connection, the network/bus interface 511 can include a wireless transceiver.

As noted above, the computing device 500 also includes the storage device 540, which can comprise a single disk or a collection of disks (e.g., hard drives). In some embodiments, storage device 540 can include flash memory, semiconductor (solid state) memory or the like. The computing device 500 can also include a Random-Access Memory (RAM) 520 and a Read-Only Memory (ROM) 522. The ROM 522 can store programs, utilities, or processes to be executed in a non-volatile manner. The RAM 520 can provide volatile data storage, and stores instructions related to the operation of applications executing on the computing device 500, e.g., the image analyzer 110, the gain map generator 120, the image specific global tone curve generator 122, the residual gain map generator 126, and so on.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for generating an image specific global tone curve, the method comprising, at a computing device:
obtaining a gain map based on a comparison between unit areas of a first image to corresponding unit areas of a second image, the gain map comprising a set of gain values for the unit areas of the first and second images;
generating a scatter plot comprising a set of points, each point comprising a gain value from the gain map and a luma value for a corresponding unit area of the first image;
determining the image specific global tone curve based on curve fitting to the scatter plot using a cost function; and
storing the image specific global tone curve with the first image.

2. The method of claim 1, further comprising:
generating a reconstructed gain map from the image specific global tone curve; and
determining a residual gain map based on a comparison between unit areas of the reconstructed gain map and corresponding unit areas of the gain map.

3. The method of claim 2, wherein the second image is replicable using a combination of the first image, the image specific global tone curve, and the residual gain map.

4. The method of claim 2, wherein the residual gain map comprises a difference between gain values of unit areas of the reconstructed gain map and gain values of corresponding unit areas of the gain map.

5. The method of claim 1, wherein:
the first image comprises a standard dynamic range (SDR) image; and
the second image comprises a high dynamic range (HDR) image.

6. The method of claim 1, further comprising:
generating a variant second image based on the first image and the image specific global tone curve.

7. The method of claim 6, wherein the variant second image differs from the second image in one or more channel values of corresponding unit areas.

8. The method of claim 1, wherein the image specific global tone curve comprises multiple contiguous segments, each segment corresponding to a cubic spline.

9. The method of claim 1, wherein the curve fitting constrains the image specific global tone curve to be a monotonically increasing function.

10. The method of claim 1, wherein the cost function comprises one of: a least squares function, a structural similarity index measure (SSIM), or a variance inflation factor (VIF).

11. The method of claim 1, wherein channel values of the first image used to generate the scatter plot comprise luminance values of unit areas of the first image.

12. The method of claim 1, wherein channel values of the first image used to generate the scatter plot comprise one or more color values of unit areas of the first image.

13. The method of claim 1, wherein each unit area corresponds to a single pixel.

14. The method of claim 1, wherein each unit area corresponds to a plurality of contiguous pixels.

15. A non-transitory computer readable storage medium configured to store instructions that, when executed by at least one processor included in a computing device, cause the computing device to generate an image specific global tone curve, by carrying out steps that include:
obtaining a gain map based on a comparison between pixels of a first image to corresponding pixels of a second image, the gain map comprising a set of gain values for the pixels of the first and second images;
generating a scatter plot comprising a set of points, each point comprising a gain value and a luma value for a corresponding unit area of the first image;
determining the image specific global tone curve based on curve fitting to the scatter plot using a cost function; and
storing the image specific global tone curve with the first image.

16. The non-transitory computer readable storage medium of claim 15, wherein the steps further include:
generating a reconstructed gain map from the image specific global tone curve; and
determining a residual gain map based on a comparison between unit areas of the reconstructed gain map and corresponding unit areas of the gain map.

17. The non-transitory computer readable storage medium of claim 16, wherein the second image is replicable using a combination of the first image, the image specific global tone curve, and the residual gain map.

18. A method for generating image specific global tone curves, the method comprising, at a computing device:
obtaining a gain map based on a comparison between pixels of a first image to corresponding pixels of a second image, the gain map comprising a set of gain values for the pixels of the first and second images;
identifying a plurality of areas of the first image;
generating, for each area of the first image:
a respective scatter plot, wherein each respective scatter plot comprises a set of points, each point comprising a gain value and a luma value for a corresponding area of the first image, and
a respective image specific global tone curve for the respective scatter plot using a respective cost function; and
storing the image specific global tone curves with the first image.

19. The method of claim 18, further comprising, prior to generating the scatter plots and image specific global tone curves:
identifying respective weights to be applied to one or more pixels of the first image, the second image, and/or the gain map; and
applying the respective weights to the one or more pixels.

20. The method of claim 18, further comprising:
receiving a selection of an image specific global tone curve among the image specific global tone curves; and
applying the image specific global tone curve against the first image.
